(19) United States
(12) Patent Application Publication
(10) Pub. No.: US 2011/0289780 A1
(43) Pub. Date: Dec. 1, 2011

(54) BLADE ILLUMINATOR

(76) Inventor: FLORIAN TIEGS, Darlington, WI (US)

(21) Appl. No.: 12/789,039

(22) Filed: May 27, 2010

(51) Int. Cl. B26B 11/00

(52) U.S. Cl. 30/123; 362/119

(57) ABSTRACT

An illuminated utility device comprising: a handheld utility device, or said utility device includes a handle and a blade; a light source that directs light towards the blade from the handle; and a power source within the handle said power source providing energy for the light source. The light source may include a LED light that directs light along the edge of the blade and the power source may include batteries.

### BACKGROUND OF THE INVENTION

1. Field of Invention

The present invention relates to an illumination device suitable for use on a knife, cutting tool or likewise.

2. Description of Related Art

Knives and similar hand tools comprise a handle and a metal cutting blade or application component. The handle provides a means for the user to grip and manipulate the knife or hand tool. In the case of a traditional knife, the blade is used for cutting and in some instances spreading of materials such as caulk or otherwise. Knives can be manufactured with a fixed blade or in some instances a foldable blade that's usually associated with a pocketknife. Types of knives used as tools include a bow knife, hunting knife, pocketknife, utility knife and wood carving knives.

Occasionally knives are used in areas where light and visibility is restricted. Because of the necessity to see the manipulation of the blade, it would be advantageous for a user to have a means to input light along the cutting edge or near the edge of the cutting blade. Some surgical knives have been equipped with such features however the complexities associated with surgical knives are not conducive to the common knife used as a tool.

### SUMMARY OF THE INVENTION

The present invention relates to an illuminated utility device comprising: a handheld utility device, or said utility device includes a handle and a blade; a means to direct light towards the blade from the handle; and a power source within the handle said power source providing energy for the means to direct light. The means to direct light may include a LED light that directs light along the edge of the blade and the power source may include batteries.

### BRIEF DESCRIPTION OF DRAWINGS

FIG. 1 depicts an application of a blade illumination device according to the present invention.

FIG. 2A depicts an alternative use of the blade illumination device according to the present invention.

FIG. 2B depicts a side view of the blade illumination device according to the present invention.

FIG. 3 depicts yet another application of the blade illuminating device according to the present invention.

### DETAILED DESCRIPTION

The present invention provides a blade illumination device that provides a beam of LED light along the cutting edge of a utility-type knife. The light may be controlled by on and off switch and is energized through the use of batteries within a storage compartment of the handle of the utility knife.

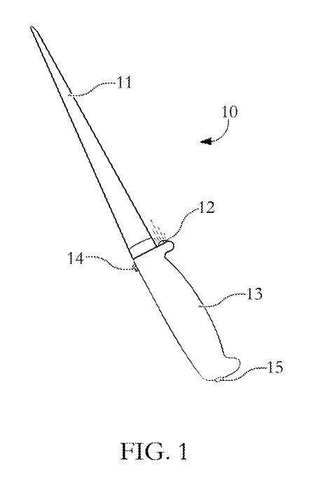

FIG. 1 depicts an exemplary embodiment of the present invention. As shown in the FIG. 1, a filet-styled utility knife 10 is shown. The filet knife 10 includes a LED light 12 positioned at the top of a handle 13. The LED light 12 directs a beam of light along the cutting edge of a blade 11 which extends from the handle 13. The LED light 12 is controlled by a on and off switch 14 which is on the opposite side of the handle adjacent to the non-cutting edge of the blade 11. Although not shown a battery storage area is provided within the handle 13 which may be inserted at the non-blade end of handle 13 through an opening 15. This embodiment of the present invention provides light along the cutting edge of the knife and may be conveniently used by the user in a low-light area.

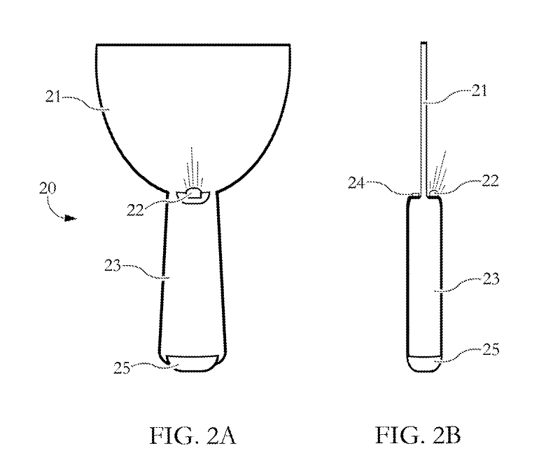

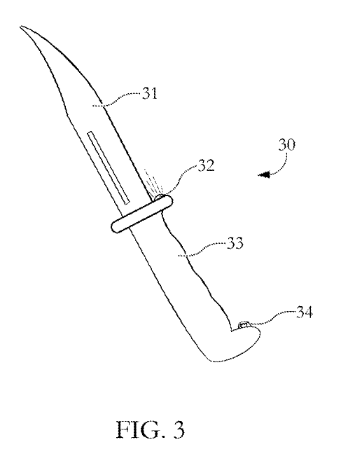

FIG. 2A depicts a drywall putty-type knife where the blade provided upon the handle is extended at a suitable width for using with the drywall. This drywall knife 20 includes blade 21 extending from handle 23. A LED light 22 is positioned at the top end of the handle just below the knife blade 21. Similar to the above-discussed embodiment, a battery storage area is provided within the handle 23 and batteries are inserted through a cap opening 25. This embodiment provides a beam of light along one side of the knife blade 21 of the drywall knife 20. FIG. 2B depicts a side view of this particular embodiment where a on and off switch 24 is on the opposite side of the knife blade 21 at the top of the handle 23. Opposite the on and off switch 24 is the LED light 22 on the opposing side of blade 21.

In a third embodiment of the present invention, a LED light is provided upon a hunting bow-type knife. A hunting knife 30 includes handle 33 where a LED light 32 is depicted at the top of the handle which directs line along the cutting edge side of blade 31. The on and off switch on the hunting knife 30 is positioned at the bottom of handle 33 along the cutting side edge of the blade 31. The hunting knife 30 further includes a battery storage area within the handle 33.

The blade illuminating system as depicted in the embodiments of the present invention provides lighting capabilities for the user and therefore may be helpful in a low light condition. In addition to batteries being stored within the handle of the particular cutting tool, the handle may also store an additional light bulb for insertion into the position for the LED light. Other features associated with this particular invention is that the LED light would be of a waterproof nature and applicable on a variety of hand and cutting tools.

What is claimed is:

1. An illuminated utility device comprising:
a handheld utility device, or said utility device includes a handle and a blade;
a means to direct light towards the blade from the handle; and
a power source within the handle said power source providing energy for the means to direct light.

2. The illuminating utility device according to claim 1, where said blade is a filet type cutting knife and the means to a direct light is directed toward the edge of the knife

3. The illuminating utility device according to claim 1, wherein said means to direct light includes a LED light that directs light along the edge of the blade.

4. The illuminating utility device according to claim 3, where said LED light is controlled by an on and off switch where said on and off switch is positioned on one side of the handle.

5. The illuminating utility device according to claim 1, wherein said power source includes battery.

6. The illuminating utility device according to claim 1, wherein said blade includes a drywall putty type knife.

7. The illuminating utility device according to claim 1, wherein blade includes a hunting bow type knife.
